(19) United States
(12) Patent Application Publication
(10) Pub. No.: US 2003/0170021 A1
(43) Pub. Date: Sep. 11, 2003

(54) Method and arrangement for measuring the optical signal quality in a fiber network using optical cross-connectors

(76) Inventor: Stefan Larsson, Stockholm (SE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,738

(22) PCT Filed: Apr. 24, 2001
(86) PCT No.: PCT/SE01/00874

(30) Foreign Application Priority Data
Apr. 28, 2000 (SE) 0001579-2

(51) Int. Cl. H04B 10/08

(52) U.S. Cl. 398/25; 398/56

(57) ABSTRACT

The present invention relates to telecommunication system/systems and is intended to make possible to implement in optical transmission networks. It provides a simple possibility to check the quality of channels after they having been put into operation, maintenance or after reconfigurations in the network.

At optical cross-connectors (OXC), which are intended to control wavelength-channels, analyzers, which can generate and receive test sequences, which are standardized for different transmission protocols, for instance SDH according to ITU or Gigabit according to IEEE, are placed.

FIG. 2 shows a possible procedure for testing of channels between two optical cross-connectors, OXC1 and OXC2. An analyzer (A 1), which is controlled from a control device for optical cross-connectors (NEM1), is connected to OXC1. A second analyzer (A 2), which is controlled from a second NEM (NEM2), is connected to OXC2.

The first analyzer is connected to the second analyzer via a channel (21) between OXC1 and OXC2, at which said channel can be tested via control from NEM1 and NEM2, which intercommunicate.

### TECHNICAL FIELD

The present invention relates to telecommunication and data communication systems. It is intended to make possible to implement in optical transmission networks which include optical cross-connectors for control of wavelength channels between client equipment. The client equipment can be SDH-equipment, IP-routers, ATM-switches or the like.

### PRIOR ART

It is known to use electronic test instruments for measuring of signals during test at establishing of electrical, electro-optical (E/O), opto-electrical (O/E) and optical systems.

There exist systems which include an electrical source built into an analyzer for electrical calibration and measuring.

There also exist systems for calibration and correction of poor impedance matching in electro-optical and opto-electrical units in electronic test instruments.

Any arrangement for measuring of optical channels in an installation in operation has not so far been produced.

### TECHNICAL PROBLEM

An optical cross-connector (OXC) is intended to control wavelength channels, or more general, optical signals, between client equipment over an optical network. Typical of an optical cross-connector is that it is transparent to transmission protocols. For that reason the optical cross-connector cannot utilize information which is transmitted/transferred as overhead in used transmission protocols, such as information about quality of the transmission.

The optical channels between OXC-units, however, may present poor transmission quality, or be quite unusable. To make it possible to offer a specified service level in the network it is important to have information about the quality of these channels available. An operator also has a need to know the quality of the channels for planning of the network and for operation and management. When this quality information cannot be read via the transmission protocol, the operator alternatively can utilize an arrangement for measuring of quality.

Increasing demands for capacity in telecommunication networks and increasing share of IP-traffic in said networks make increasing demands upon the management of the networks. By that, increased demands will be made for optical multichannel system and in that included cross-connectors and managing systems in connection to these cross-connectors.

The increasing demands for capacity and the fact that the IP-traffic will have an increasing share of the total traffic, also make new demands for flexibility in the networks. By that, also demands are made for possibilities for re-configuration, and in connection with that it is important to follow up the re-configuration with check of the quality of the channels.

### TECHNICAL SOLUTION

At each OXC an analyzer is placed which can generate and receive test sequences standardized for different transmission protocols, for instance SDH according to ITU or Gigabit Ethernet according to IEEE. The analyzer is either connected to a port at OXC in the same way as client and transmission equipment or is integrated in OXC.

### ADVANTAGES

The invention provides possibility to automatically check the quality of channels which are put into operation.

The invention provides a simple possibility to check the quality of channels after they have been put into operation, or after reconfigurations in the network.

### LIST OF FIGURES

FIG. 1 shows an optical cross-connector (OXC) equipped with analyzer (link tester). To each OXC there is a Network Element Manager (NEM) which manages management functions for OXC and communication with the world around and other OXC-units.

FIG. 2 shows two communicating optical cross-connectors (OXC1 and OXC2) and a possible set up for test with two analyzers (analyzer 1 and analyzer 2), where a channel has been established between the optical cross-connectors.

FIG. 3 shows two communicating optical cross-connectors (OXC1 and OXC2) and a possible set up for analyzer test with feedback, where two established channels between the optical cross-connectors are interconnected to a loop.

### EXPLANATION OF TERMS

ATM Asynchronous Transfer Mode. A connection oriented technology, based on a “cell” of defined size as transmission/transfer mechanism.

CoS Class of Service.

E/O Electro-Optical device. Electro-optical unit. In most cases stands for electro-optical conversion.

IP Internet Protocol. Protocol which is used in Internet.

| | |
|---|---|
| IP-router | Router which routes IP-traffic. |
| Lambda | Arrangement where wavelength is used as |
| Switching | base (label) for cross-connection. |
| NEM | Network Element Manager. Control arrangement for |
| | optical cross-connectors. |
| O/E | Opto-Electrical device. Opto-electrical unit.In |
| | most cases stands for opto-electrical conversion |
| | (detector) |
| OXC | Optical cross-connector. |
| QoS | Quality of Service. Quality criteria for data |
| | transmission. |
| SDH | Synchronous Digital Hierarchy. Standard for |
| | supervised transmission network with components |
| | such as ADM and cross-connectors. |
| WDM | Wavelength-Division Multiplex. Wavelength |
| | multiplexing in optical multichannel system, |
| | optical multichannel systems. |

### DETAILED DESCRIPTION

The description below refers to the figures in the appendix of drawings.

### Environment of the Invention

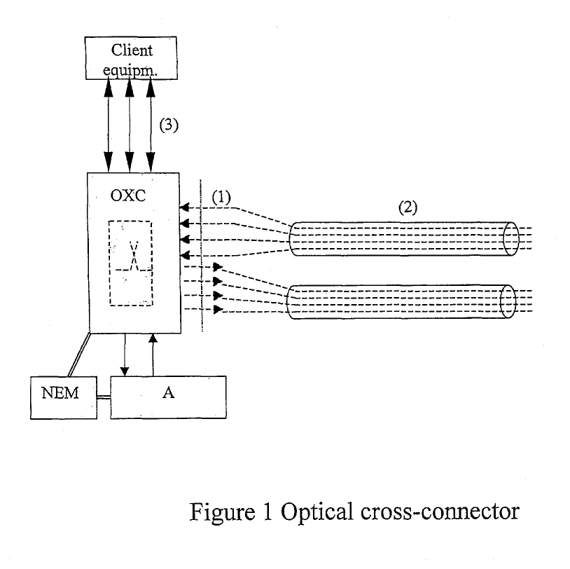

In the invention is dealt with analyze of optical multichannel systems (WDM), in which the optical cross-connector (OXC) constitutes an important component, see FIG. 1. The cross-connector (OXC) has remote ports (1) for connection via optical fiber (2) to other nodes/cross-connectors. The cross-connector also has local ports (3) for traffic to clients. These local ports can be electrical or optical. In addition to these ports there are control arrangements (NEM) for OXC.

Cross-connection in the optical plane means that the clients are interconnected end-to-end over the optical network. Wavelength-based routing in the optical network can be regarded as connection by means of labels, where the wavelength constitutes the label. This means that lambda-switching is used for connection of client equipment based on physical port. The number of labels therefore is equal to the number of client ports and cannot exceed the number of labels, or wavelengths, which the optical network can manage.

Lambda switching can either be controlled by the topology of the network, or by the traffic in the network; connection can be established based on either origin or flow.

### Quality of Service and Class of Service

The network term QoS (Quality of Service) means that transmission speed, delay, failure rate, probability that packet/packets is/are lost etc, can be measured, improved and, in some cases, be guaranteed in advance. QoS is especially important to broadband, interactive or continuous transmissions which require high capacity, for instance video and other multimedia.

QoS can be divided into two parts; quantitative QoS and qualitative QoS:

By quantitative QoS is meant that, for instance, transmission speed and delay are set to specific values, for instance a transmission speed of 10 kbit/s, and a delay of less than 10 ms. It is quantitative QoS that generally is called QoS.

In qualitative QoS there are no specific values for delay, transmission speed etc, but instead are different types of traffic given different priority. The priorities are relative and indicate for instance that certain traffic shall have less delay than certain other traffic. Qualitative QoS is often called CoS (Class of Service).

Traditional IP-traffic provides no support to offer QoS, but by certain support functions some form of QoS can be offered. Further, it is possible to offer quality classes (CoS) in underlying carriers such as ATM or SDH.

### Suggested Embodiment

At optical cross-connectors, analyzers are placed which can generate and receive test sequences which are standardized for different transmission protocols, for instance SDH according to ITU, or Gigabit Ethernet according to IEEE. The analyzers (A) are either connected to ports at optical cross-connectors, as client and transmission equipment, or are integrated in OXC. Control devices for the analyzers can be arranged by communication with NEM, which also attends to control of OXC. This is shown in FIG. 1, where the communication between analyzer (A) and NEM (NEM) is exemplified by a direct connection between NEM and analyzer.

Important points of time for link testing are at activation of a new OXC or transmission equipment and after repairing of transmission equipment (for instance fiber cable) or OXC. To maintain a good quality in installation and infrastructure it is also important to have possibility to test parts of the installation which have been put into operation. For that reason link testing also shall be possible to perform at point of time which has not been decided in advance.

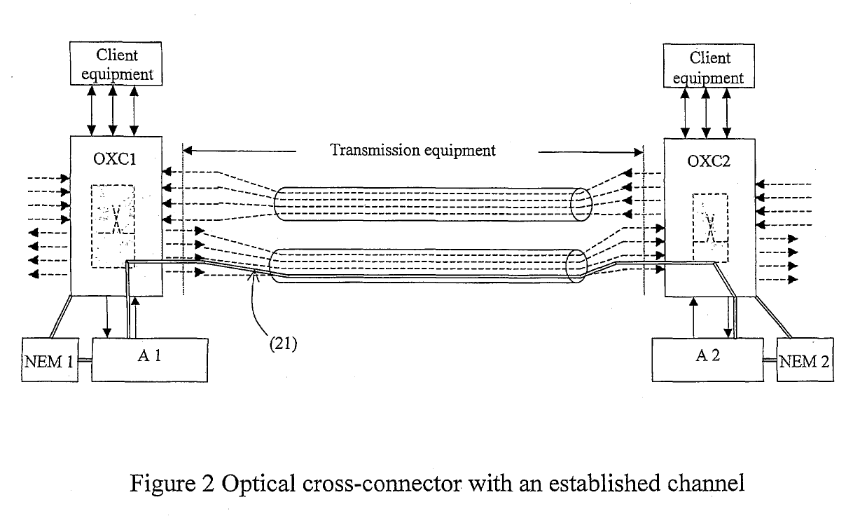

FIG. 2 shows a possible procedure for testing of channel between two optical cross-connectors, OXC1 and OXC2. A first analyzer (A1), which is controlled from a first NEM (NEM1), is connected to OXC1. A second analyzer (A2), which is controlled from a second NEM (NEM2), is connected to OXC2.

Said channel (21) which shall be tested is established between OXC1 and OXC2. The first analyzer (A1) is connected to the second analyzer (A2) via said channel (21) between OXC1 and OXC2, at which said channel can be tested via control from NEM1 and NEM2, which intercommunicate.

Testing is repeated for each channel that shall be tested.

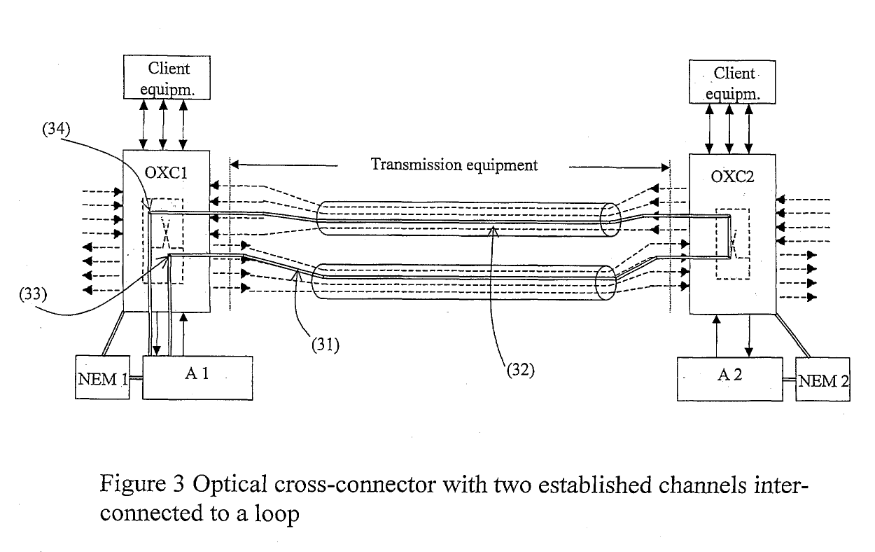

FIG. 3 shows an alternative procedure for testing of channels between two optical cross-connectors, OXC1 and OXC2. An analyzer (A1), which is controlled from a NEM (NEM1), is connected to OXC1.

A channel (31) is established between OXC1 and OXC2. By cooperation between NEM1 and NEM2, which controls OXC2, a feed back is made in OXC2 and one more channel is established between OXC1 and OXC2. By this connection a loop is obtained with two endpoints in OXC1. The first analyzer (A1) is connected to these channels, that is the end points of the loop (33, 34) and can by the loop perform an analysis of the two established channels. Testing is repeated so that all channels which are intended to be tested will be tested.

A second analyzer (A2), which is controlled from a second NEM (NEM2), can be connected to OXC2. This second analyzer then can be connected to the channels and in the same way make measuring from OXC2. By comparison of the measuring results from the analyzers, a measuring result is obtained with higher degree of reliability.

When the testing is performed for all channels, the operator who operates the network will have control over the transmission quality of the connections in the network that is offered to the customers.

The transmission quality link by link is best determined by support of standardized or manufacturer specific test sequences.

The result of the measuring consequently shows the quality of the links. By this result is then obtained information about which transmission protocols, which bit rates, which line codings and which modulation formats etc that can be used. This information is then used by the managing system when set ups in the network are requested.

A secondary effect of the link testing is that the two involved OXC-units make a listing of their common links and that the function of the connection element in OXC can be verified.

### Alternative Use

The described way to control channels can be used both in connection with that channels are put into operation after repair, or other maintenance such as when channels are put into operation at start of new installations or parts of installations, as at addition where a limited number of channels are put into operation.

The procedure as above is consequently suitable also in connection with measures such as repair or other maintenance, in an installation. At use of the method in connection with maintenance measures or other measures when only a part of the installation is concerned, the procedure as above can be used to test the whole installation. The testing can alternatively be limited by existing channels which have not been put out of operation not being tested, at which only the channels which have been concerned by a measure are tested.

It is also possible to test other connections such as lines to client equipment and other installations.

The invention is not limited to above described embodiments but can in addition be subject to modifications within the frame of the following patent claims and the idea of invention.

1. An arrangement to measure the quality of channels between client equipment, for instance SDH, IP-routers or ATM-switches, in an optical transmission network which includes optical cross-connectors for control of wavelength channels or optical signals, analyzers (A) are arranged to generate and receive test sequences, a first cross-control equipment (NEM1), which control a first optic connector and a second cross-control equipment (NEM2), which control a second optic connector, and mentioned first and second control equipment (NEM2, NEM2) are arranged to
establish two channels (31, 32) between the first optic cross- connector and the second optic cross-connector,
cross-connect mentioned channels in the second optic cross-connector to a first loop circuit, and a first analyzer, which is arranged at the first optic cross-connector, is arranged to perform a first measurement of quality on the first loop circuit and mentioned two channels,
cross-connect said two channels in said first optical cross-connector to a second loop circuit, at which a second analyzer, which is arranged at the first optic cross-connector, is arranged to perform a second measurement of quality on the second loop circuit and mentioned two channels, and the analyzers are arranged to perform mentioned measurement of quality in connection with put into service or maintenance after put into service, and
compare the results of measurement from the first measurement of quality at the first analyzer with the measurement of quality at the second analyzer.

2. Arrangement as claimed in patent claim 1, wherein the first and second analyzer is arranged to be controlled by a control equipment (NEM1, NEM2) which control the optical cross-connector at which each analyzer is arranged.

3. Arrangement as claimed in patent claim 1 or 2, wherein the first and second analyzer is arranged to perform mentioned first and second measurement of quality atomically on channels taken into use.

4. Arrangement as claimed in any of patent claims 1-3, wherein the first and second analyzer is arranged to repeat the first and the second measurement of quality on all channels intended to be measured.

5. An arrangement as claimed in patent claim 1-4, wherein said analyzers (A) are connected to ports at each optical cross-connectors (OXC).

6. Arrangement as claimed in any of patent claims 1-4, where mentioned analyzer (A) is integrated in each optical cross-connector

7. A method to measure the quality of channels between client equipment in an optical transmission network, which includes optical cross-connectors for control of wavelength channels or optical signals, analyzers arranged to generate and receive test sequences, a first control equipment (NEM1), which control a first optic cross-connector, and a second control equipment (NEM2), which control a second optic cross-connector, including the steps,
establish a first and a second channel between the first optic cross-connector and the second optic cross-connector,
cross-connect mentioned first and second channel in the second optic cross-connector to a first loop circuit, wherein a first analyzer, which is arranged at the first optic cross-connector, performs a first measurement of quality on mentioned first loop circuit and in connection thereto on mentioned first and second channel,
cross-connect mentioned first and second channel in the first optical cross-connector to a second loop circuit, and a second analyzer, which is arranged at the second optical cross-connector, performs a second measurement of quality on mentioned second loop and in connection thereto on mentioned first and second channel, and mentioned measurement of quality is performed in connection to put in sevice or maintenance or after put in service and,
compare the results of the measurements in mentioned first measurement of quality at the first analyzer to the measurements of quality at mentioned second measurement of quality at the second analyzer.

8. A method as claimed in patent claim 7, where the first and the second analyzer is controlled by the control equipment which controls the optical cross-connector at which each analyzer is arranged.

9. A method as claimed in patent claim 7 or 8, where mentioned comparison is used to create a higher grade of confidence in the measurement.

10. A method as claimed in any of patent claims 7-9, where mentioned measurement of quality is performed automatically on channels set in service. u

11. A method as claimed ipn any of patent claims 7-10, where mentioned first and mentioned second measurement of quality is repeated in a way that all channels intended to be checked between the first and the second optical cross-connector is checked.

12. A method as claimed in any of patent claims 7-11, where the analyzers (A) are connected to ports on corresponding optical cross-connector.

13. A method as claimed in any of patent claims 7-11, where the analyzers (A) are integrated in corresponding optical cross-connector.
